(19) United States
(12) Patent Application Publication
(10) Pub. No.: US 2022/0350084 A1
(43) Pub. Date: Nov. 3, 2022

(54) Optical Connecting Structure

(71) Applicant: Nippon Telegraph and Telephone Corporation, Tokyo (JP)

(72) Inventors: Hiroshi Ishikawa, Tokyo (JP); Makoto Abe, Tokyo (JP); Norio Sato, Tokyo (JP); Atsushi Aratake, Tokyo (JP)

(73) Assignee: Nippon Telegraph and Telephone Corporation, Tokyo (JP)

(21) Appl. No.: 17/621,154

(22) PCT Filed: Jun. 21, 2019
(86) PCT No.: PCT/JP2019/024731

§ 371 Date: Dec. 20, 2021

(51) Int. Cl. G02B 6/30

(52) U.S. Cl. CPC G02B 6/30

(57) ABSTRACT

An embodiment optical coupling structure includes: at least one optical element; at least one optical fiber which has an end surface facing the optical element; and an adhesive agent which is applied to at least the end surface and a part of the optical element so as to optically and mechanically couple the optical element and the optical fiber, wherein both a contact angle which a surface of the optical element and a surface of the adhesive agent make and a contact angle which a surface of the optical fiber and the surface of the adhesive agent make are less than 90 degrees. With such a configuration, alignment between the optical element and the optical fiber can be realized by passive alignment so that a mounting time and a mounting cost in coupling the optical element and the optical fiber can be reduced.

### CROSS-REFERENCE TO RELATED APPLICATION

This application is a national phase entry of PCT Application No. PCT/JP2019/024731, filed on Jun. 21, 2019, which application is hereby incorporated herein by reference.

### TECHNICAL FIELD

The present invention relates to an optical coupling structure, and more specifically to an optical coupling structure between an optical element and an optical fiber.

### BACKGROUND ART

An industrial field which uses optical signal processing technology such as optical communication or optical sensing has been in rapid and continuous progress with its related fields. Electronic circuit technology has been in rapid and continuous progress as in optical signal processing technology and is often used in combination with the optical signal processing technology. However, optical signal processing technology has some problems compared to electronic circuit technology. These are compacting and convenient coupling.

### Compacting

In electronic circuit technology focusing on silicon, miniaturization has been promoted extremely actively. This is because, in electronic circuit technology, miniaturization directly leads to the acquisition of high performance in accordance with a scaling law.

On the other hand, in optical signal processing technology, in the case of a spatial optical system, a size of system becomes extremely large. Also in a planar lightwave circuit (hereinafter, referred to as “PLC”) which can realize a system smaller than the spatial optical system, due to a cutoff condition, even a size of a waveguide which is a most fundamental optical element becomes an order of several μm to several hundred nm. Accordingly, the optical signal processing technology is liable to require a large device size compared to electronic circuit technology.

### Convenient Coupling

In electronic circuit technology, in a low frequency domain, a signal can be transmitted conveniently by simply coupling a conductor made of metal or the like. Also in high frequency domain, a pluggable coupling technique such as an RF connector has matured. To the contrary, in the case of optical signal processing technology, simply coupling a medium which transmits an optical signal such as an optical fiber cannot realize favorable coupling. To acquire favorable coupling in optical signal processing technology, the alignment between devices with high accuracy is indispensable. For example, in the case of a device which has a single mode waveguide, performing the alignment with high accuracy of sub μm order is desired, although the alignment also depends on a material and a design.

In optical signal processing technology, in general, an optical fiber used for transmission of an optical signal, and an optical element which performs processing of the transmitted optical signal are used. Examples of the optical element which performs the processing of the optical signal include a lens, a PLC, a fiber Bragg grating (FBG), a laser diode (LD), and a photodetector (PD). In a system which realizes optical signal processing technology, optical coupling between the optical element and the optical fiber as described above becomes indispensable. A single-mode optical fiber is used for transmitting an optical signal in general. Accordingly, alignment with high accuracy of sub μm order is desired in the optical coupling between the optical element and the optical fiber.

One of representative couplings between the optical element and the optical fiber described above is direct optical coupling between the PLC and the optical fiber.

In an example of bonding a PLC and an optical fiber shown in FIG. 7, optical coupling is formed between a quartz-based PLC 701 and an optical fiber 702. The quartz-based PLC 701 includes a waveguide 703, and the waveguide is formed of a core made of SiO₂ doped with Ge, and a clad made of non-doped SiO₂. In FIG. 7, a case is exemplified where the waveguide 703 constitutes a Mach-Zehnder interferometer. However, the Mach-Zehnder interferometer is only an example, and the quartz-based PLC 701 may have any circuit. A glass block 706 and the quartz-based PLC 701 are bonded to each other in advance. The optical fibers 702 and a fiber block 705 are also bonded to each other in advance. In such a configuration, bonding between the glass block 706 and the quartz-based PLC 701 and bonding between the optical fibers 702 and the fiber block 705 are formed physically prior to optical coupling. Such a configuration is a mode which is often used in the quartz-based PLC.

In forming such configuration, in general, a core cross-section of each of the optical fibers 702 which are bonded to the fiber block 705 is made to approach an area in the vicinity of a core cross section of the optical waveguide 703 at an end surface of the quartz-based PLC 701, the optimum position of the optical waveguides 703 and the optical fibers 702 are determined by active alignment and, thereafter, that is, after alignment of optical coupling is performed, these devices are fixed to each other by an adhesive agent 704.

The active alignment is an alignment technique which adjusts positions of the PLC and the optical fibers by allowing light to pass through the PLC and the optical fibers and by observing propagation light using a dedicated apparatus in general. In the active alignment, in general, usually, intensity of a propagation light is observed, and adhesion is performed when it is determined that the position at which intensity of the propagation light becomes maximum is the most appropriate position.

Contrary to such active alignment, there has been also proposed a concept referred to as passive alignment. Passive alignment is a technology which performs alignment by making use of physical structures of elements to be aligned, for example, by making use of fitting engagement or a butting. The passive alignment does not require a dedicated apparatus, and also does not require optical propagation and the observation of the optical propagation. However, at the current stage of technology, in the optical coupling between an optical element including a PLC and an optical fiber, matured passive alignment technology does not exist. Accordingly, at present, the optical coupling between an optical element and an optical fiber shown in FIG. 7 is performed on a premise of active alignment.

### CITATION LIST

### Non-Patent Literature

Non-Patent Literature 1: Masao Kawachi, The transactions of the Institute of Electronics, Information and Communication Engineers. C Vol.J81-C2 No.6 pp.513-523

### SUMMARY

### Technical Problem

However, the active alignment has a drawback that the active alignment requires a complicated mounting apparatus and requires a long mounting time and a high mounting cost. The present invention has been made to overcome these drawbacks, and it is an object of the present invention to provide an optical coupling structure which can reduce a mounting time and a mounting cost necessary for coupling an optical element and an optical fiber by realizing the alignment between the optical element and the optical fiber by passive alignment.

### Means for Solving the Problem

An optical coupling structure according to an embodiment of the present invention includes: at least one optical element; at least one optical fiber which has an end surface facing the optical element; and an adhesive agent which is applied to at least the end surface and a part of the optical element so as to optically and mechanically couple the optical element and the optical fiber, wherein both a contact angle which a surface of the optical element and a surface of the adhesive agent make and a contact angle which a surface of the optical fiber and the surface of the adhesive agent make are less than 90 degrees.

### Effects of Embodiments of the Invention

According to embodiments of the present invention, by making both the contact angle which the surface of the optical element and the surface of the adhesive agent make and the contact angle which the surface of the optical fiber and the surface of the adhesive agent make less than 90 degrees, the coupling between the optical element and the optical fiber can be realized by passive alignment by making use of a surface tension of the adhesive agent and hence, a mounting time and a mounting cost for the coupling between the optical element and the optical fiber can be reduced.

### BRIEF DESCRIPTION OF THE DRAWINGS

FIG. 1A is a perspective view describing an overall configuration of an optical coupling structure according to a first embodiment of the present invention.

FIG. 1B is a cross-sectional view taken along a yz plane of the optical coupling structure according to the first embodiment.

FIG. 1C is a view of an end surface of an optical fiber as viewed from an adhering surface.

FIG. 1D is a view of a lens as viewed from an adhering surface.

FIG. 2A is a perspective view describing an overall configuration of an optical coupling structure according to a second embodiment of the present invention.

FIG. 2B is a cross-sectional view taken along a yz plane of the optical coupling structure according to the second embodiment.

FIG. 2C is a view of an end surface of an optical fiber as viewed from an adhering surface.

FIG. 2D is a view of a lens as viewed from an adhering surface.

FIG. 3A is a perspective view describing an overall configuration of an optical coupling structure according to a third embodiment of the present invention.

FIG. 3B is a cross-sectional view taken along a yz plane of the optical coupling structure according to the third embodiment.

FIG. 3C is a view of the optical coupling structure according to the third embodiment as viewed from a y direction.

FIG. 3D is a view of an end surface of an optical fiber as viewed from an adhering surface.

FIG. 3E is a view of a PLC as viewed from an adhering surface.

FIG. 4A is a perspective view describing an overall configuration of an optical coupling structure according to a fourth embodiment of the present invention.

FIG. 4B is a cross-sectional view taken along a yz plane of the optical coupling structure according to the fourth embodiment.

FIG. 4C is a view of the optical coupling structure according to the fourth embodiment as viewed from a y direction.

FIG. 4D is a view of an end surface of an optical fiber as viewed from an adhering surface.

FIG. 4E is a view of a PLC as viewed from an adhering surface.

FIG. 5A is a perspective view describing an overall configuration of an optical coupling structure according to a fifth embodiment of the present invention.

FIG. 5B is a cross-sectional view taken along a yz plane of the optical coupling structure according to the fifth embodiment.

FIG. 5C is a view of the optical coupling structure according to the fifth embodiment as viewed from a y direction.

FIG. 5D is a view of an end surface of an optical fiber as viewed from an adhering surface.

FIG. 5E is a view of a PLC as viewed from an adhering surface.

FIG. 6A is a perspective view describing an overall configuration of an optical coupling structure according to a sixth embodiment of the present invention.

FIG. 6B is a cross-sectional view taken along a yz plane of the optical coupling structure according to the sixth embodiment.

FIG. 6C is a view of the optical coupling structure according to the sixth embodiment as viewed from a y direction.

FIG. 6D is a view of an end surface of an optical fiber as viewed from an adhering surface.

FIG. 6E is a view of a PLC as viewed from an adhering surface.

FIG. 7 is a view for describing a conventional optical coupling between an optical element and an optical fiber.

### DETAILED DESCRIPTION OF ILLUSTRATIVE EMBODIMENTS

Hereinafter, embodiments of an optical coupling structure according to embodiments of the present invention are described with reference to drawings.

### First Embodiment

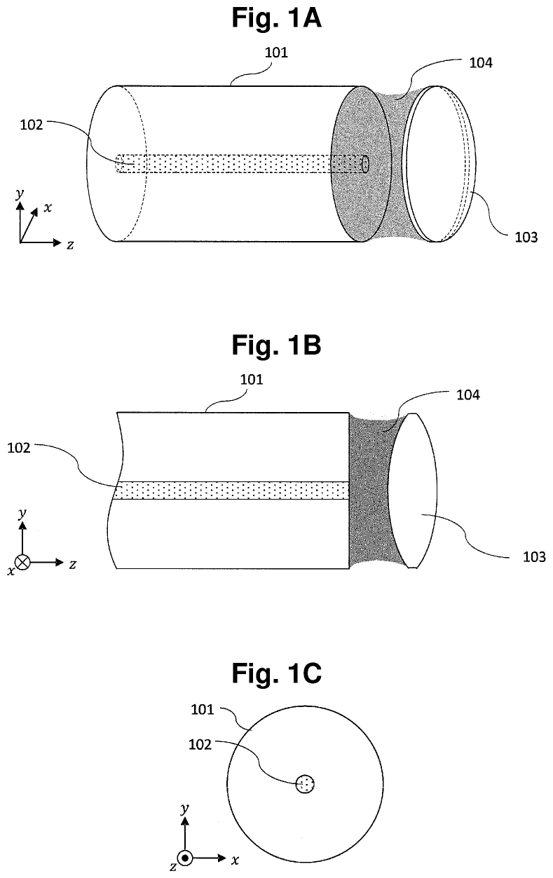

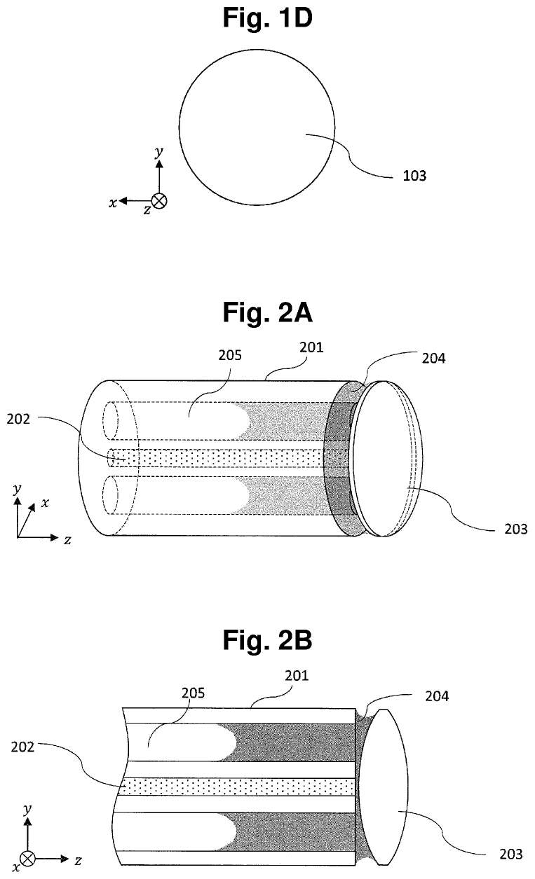

As shown in FIG. 1A to FIG. 1D, an optical coupling structure according to a first embodiment of the present invention is an optical coupling structure where a lens 103 and an optical fiber 101 are coupled to each other by an adhesive agent 104. An optical fiber core 102 is formed in the optical fiber 101. The adhesive agent 104 is applied to a surface of the lens 103 which faces the optical fiber 101 and an end surface of the optical fiber 101 which faces the lens. By adhering the lens 103 to the end surface of the optical fiber 101 by the adhesive agent 104, the optical fiber 101 and the lens 103 are coupled to each other optically and mechanically by the adhesive agent 104.

As shown in FIG. 1A and FIG. 1B, both a contact angle which the surface of the lens 103 and a surface of the adhesive agent 104 make and a contact angle which the end surface of the optical fiber 101 and the surface of the adhesive agent 104 make are less than 90 degrees.

With such a structure, at a point of time before the adhesive agent 104 is cured, a relative position between the optical fiber 101 and the lens 103 changes so as to assume a stable state because of an action of a surface tension of the adhesive agent 104. Accordingly, by designing materials, profiles and surface states of the optical fiber 101 and the lens 103 and a material of the adhesive agent 104 such that the optical fiber 101 and the lens 103 assume an alignment position in a state where the surface tension is balanced, spontaneous alignment can be realized between the optical fiber 101 and the lens 103. For example, it may be considered that the end surface of the optical fiber 101 and the surface of the lens 103 which faces the end surface of the optical fiber 101 respectively have shapes which are in rotation symmetry about an optical axis.

By curing the adhesive agent 104 after the spontaneous alignment takes place at a point of time before the adhesive agent 104 is cured, stable optical coupling can be obtained. Accordingly, optical coupling between the optical fiber 101 and the lens 103 can be realized by controlling the optical fiber 101 and the lens 103 in an x axis direction and a y axis direction with high accuracy by using only passive alignment without using active alignment. Further, a mounting time and a mounting cost can be reduced compared to a case where active alignment is used.

It is desirable that the adhesive agent 104 exhibit an optically small loss and hence, it is preferable to use an optical-use adhesive agent as the adhesive agent 104. Further, a thermosetting type adhesive agent may be used as the adhesive agent 104, and an ultraviolet curing type adhesive agent may be used as the adhesive agent 104.

### Second Embodiment

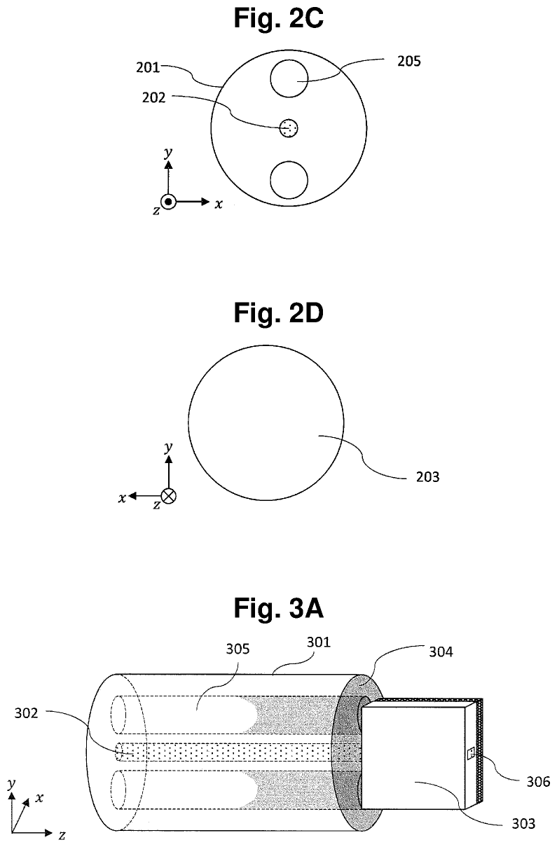

An optical coupling structure according to a second embodiment is an optical coupling structure where a lens 203 and an optical fiber 101 are coupled to each other by an adhesive agent 104 in the same manner as the optical coupling structure according to the first embodiment described above. As shown in FIG. 2A to FIG. 2C, the optical fiber 201 in the optical coupling structure according to the second embodiment is a so-called hole-formed optical fiber which includes holes 205 opening at an end surface in addition to an optical fiber core 202.

In this embodiment, the hole-formed optical fiber 201 includes, as the holes 205, hollow holes having a columnar shape which are formed in a clad portion parallel to the optical fiber core 202. That is, the hole-formed optical fiber 201 includes the hollow holes having a columnar shape which are formed parallel to a waveguide direction of the optical fiber 201. As shown in FIG. 2A to FIG. 2C, in this embodiment, as viewed from a z direction, two hollow holes are arranged at symmetrical positions with respect to the optical fiber core 202. The respective holes 205 are formed of a hollow hole having a circular columnar shape.

A part of an adhesive agent 204 has entered the holes 205. The lens 203 is fixed to an end surface of the optical fiber 201 by the adhesive agent 204. As a result, the hole-formed optical fiber 201 and the lens 203 are coupled to each other optically and mechanically by the adhesive agent 204.

As shown in FIG. 2D, there is no difference between a surface of the lens 203 which faces the end surface of the optical fiber 201 and the surface of the lens 103 in the optical coupling structure according to the first embodiment.

Also in the optical coupling structure according to this embodiment, both a contact angle which the surface of the lens 203 and a surface of the adhesive agent 204 make and contact angles which the end surface of the optical fiber 201 and wall surfaces of the holes 205 and the adhesive agent 204 make are less than 90 degrees.

Accordingly, by designing materials, profiles, and surface states of the hole-formed optical fiber 201, the lens 203 and the holes 205 and a material of the adhesive agent 204 such that a contact angle between a surface of the element which is brought into contact with the adhesive agent 204 before curing and the adhesive agent 204 before curing becomes less than 90 degrees, at a point of time before the adhesive agent 204 is cured, the relative position between the hole-formed optical fiber 201 and the lens 203 changes so as to assume a stable state because of an action of a surface tension and hence, the hole-formed optical fiber 201 and the lens 203 assume alignment positions in a state where the surface tension is balanced. Accordingly, by curing the adhesive agent 204 after spontaneous alignment and a capillary action take place, the spontaneous alignment can be realized between the hole-formed optical fiber 201 and the lens 203.

When the adhesive agent 204 is applied to the end surface of the hole-formed optical fiber 201, a part of the adhesive agent 204 enters the holes 205 of the hole-formed optical fiber 201 because of a capillary action. Since the adhesive agent 204 before curing flows into the holes 205 by a capillary action, a distance between the hole-formed optical fiber 201 and the lens 203 can be controlled. By curing the adhesive agent 204 after the spontaneous alignment and a capillary action at a point of time before the adhesive agent 204 is cured take place, it is possible to acquire stable optical coupling.

Accordingly, optical coupling between the hole-formed optical fiber 201 and the lens 203 can be realized by controlling the hole-formed optical fiber 201 and the lens 203 in an x axis direction, a y axis direction and a z axis direction with high accuracy by using only passive alignment without using active alignment. Further, a mounting time and a mounting cost can be reduced compared to a case where active alignment is used.

In this embodiment, for example, as shown in FIG. 2D, two holes 205 are formed in the optical fiber 201 at symmetrical positions with respect to the optical fiber core 202. However, the number of holes formed in the optical fiber 201 and the arrangement of such holes can be selected as desired for realizing passive alignment.

### Third Embodiment

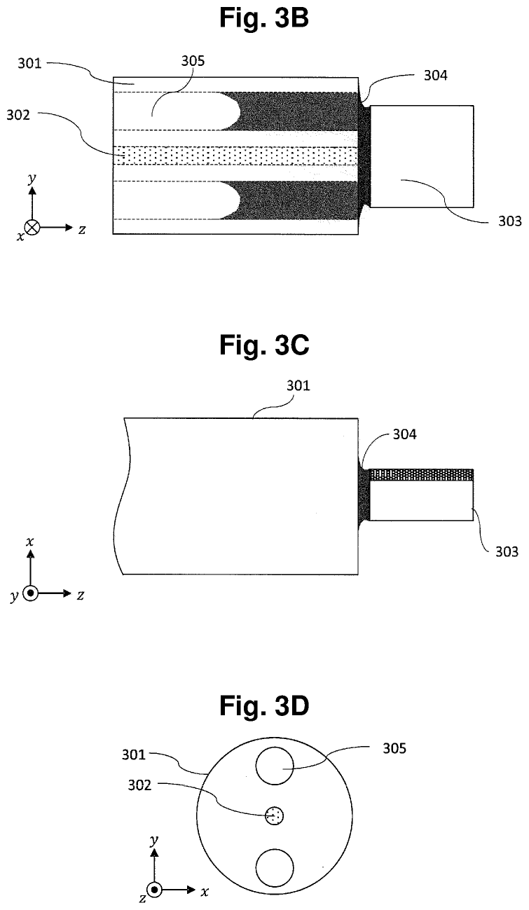

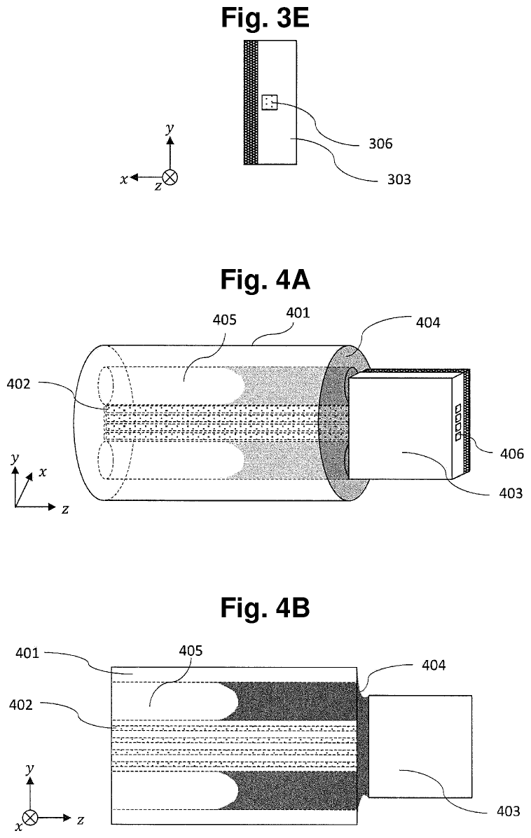

As shown in FIG. 3A to FIG. 3E, an optical coupling structure according to a third embodiment of the present invention is a structure where a hole-formed optical fiber 301 and a PLC 303 are coupled to each other by an adhesive agent 304.

The configuration of the hole-formed optical fiber 301 is equal to the configuration of the hole-formed optical fiber 201 according to the second embodiment. That is, the optical fiber 301 includes, as holes 305, two hollow holes having a circular columnar shape formed parallel to an optical fiber core 302. That is, the optical fiber 301 includes two hollow holes having a circular columnar shape formed along a waveguide direction of the optical fiber 301. Two holes are formed at symmetrical positions with respect to the optical fiber core 302 as viewed from a y direction as shown in FIG. 3C.

On the other hand, as shown in FIG. 3A, FIG. 3B and FIG. 3E, a PLC core 306 is formed in the PLC 303.

As shown in FIG. 3B, in the optical coupling structure according to this embodiment, the PLC 303 is fixed to an end surface of the optical fiber 301 by the adhesive agent 304, and an optical axis of the optical fiber core 302 and an optical axis of the PLC core 306 are aligned with each other. Accordingly, the optical fiber 301 and the PLC 303 are coupled to each other optically and mechanically. In such a configuration, a part of the adhesive agent 304 has entered the holes 305.

Also in the optical coupling structure according to this embodiment, as shown in FIG. 3B and FIG. 3C, both a contact angle which a surface of the PLC 303 and a surface of the adhesive agent 304 make and contact angles which the end surface of the optical fiber 301 and wall surfaces of the holes 305 and the surface of the adhesive agent 304 make are less than 90 degrees.

Accordingly, by designing materials, profiles and surface states of the hole-formed optical fiber 301, the PLC 303 and the holes 305 and a material of the adhesive agent 304 such that a contact angle between a surface of the element which is brought into contact with the adhesive agent 304 before curing and the adhesive agent 304 before curing becomes less than 90 degrees, at a point of time before the adhesive agent 304 is cured, a relative position between the hole-formed optical fiber 301 and the PLC 303 changes so as to assume a stable state because of an action of a surface tension of the adhesive agent 304 and hence, the hole-formed optical fiber 301 and the PLC 303 assume alignment positions in a state where the surface tension is balanced. Accordingly, by curing the adhesive agent 304 after spontaneous alignment and a capillary action take place, the spontaneous alignment can be realized between the hole-formed optical fiber 301 and the PLC 303.

Further, the adhesive agent 304 before curing flows into the holes 305 of the hole-formed optical fiber 301 because of a capillary action and hence, it is possible to control a distance between the hole-formed optical fiber 301 and the PLC 303 and the inclination of the optical fiber 301 and the PLC 303 in a rotational direction about a z axis.

By curing the adhesive agent 304 after the spontaneous alignment and a capillary action at a point of time before the adhesive agent 304 is cured take place, stable optical coupling can be obtained. Accordingly, optical coupling between the hole-formed optical fiber 301 and the PLC 303 can be realized by controlling the positions of the hole-formed optical fiber 301 and the PLC 303 in an x axis direction, a y axis direction and a z axis direction and the inclination of the hole-formed optical fiber 301 and the PLC 303 in the rotational direction about the z axis with high accuracy using only passive alignment without using active alignment. Further, a mounting time and a mounting cost can be reduced compared to a case where active alignment is used.

In this embodiment, for example, as shown in FIG. 3D, two holes 305 are formed in the optical fiber 301 at symmetrical positions with respect to the optical fiber core 302. However, the number of holes formed in the optical fiber 301 and the arrangement of such holes can be selected as desired for realizing passive alignment.

### Fourth Embodiment

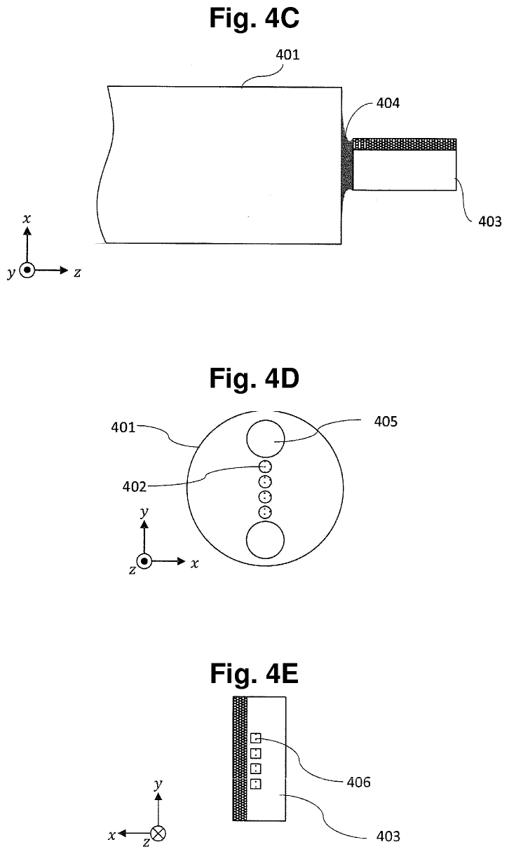

As shown in FIG. 4A to FIG. 4E, an optical coupling structure according to a fourth embodiment of the present invention is a structure where a hole-formed multicore optical fiber 401 and a PLC 403 are coupled to each other by an adhesive agent 404.

As shown in FIG. 4A and FIG. 4B, the hole-formed multicore optical fiber 401 includes: a plurality of optical fiber cores 402; and two hollow holes having a circular columnar shape which are formed parallel to the optical fiber core 402, that is, along a waveguide direction of the hole-formed multicore optical fiber 401 as holes 405. In this embodiment, as shown in FIG. 4D, the plurality of optical fiber cores 402 and two holes 405 are arranged on one straight line as viewed in a z direction, and two holes 405 are disposed at symmetrical positions with respect to the optical fiber core 402.

On the other hand, as shown in FIG. 4A, FIG. 4B and FIG. 4E, a plurality of PLC cores 406 are formed in the PLC 403. These PLC cores 406 are also arranged on one straight line as viewed in a −z direction.

As shown in FIG. 4B, in the optical coupling structure according to this embodiment, the PLC 403 is fixed to an end surface of the hole-formed multicore optical fiber 401 by the adhesive agent 404, and optical axes of the plurality of optical fiber cores 402 of the hole-formed multicore optical fiber 401 and optical axes of the plurality of PLC cores 406 of the PLC 403 are respectively aligned with each other. Accordingly, the hole-formed multicore optical fiber 401 and the PLC 403 are coupled to each other optically and mechanically. In such a configuration, a part of the adhesive agent 404 has entered the holes 405.

As shown in FIG. 4B and FIG. 4C, also in the optical coupling structure according to this embodiment, both a contact angle which a surface of the PLC 403 and a surface of the adhesive agent 404 make and contact angles which the end surface of the hole-formed multicore optical fiber 401 and wall surfaces of the holes 405 and the surface of the adhesive agent 404 make are less than 90 degrees.

Accordingly, by designing materials, profiles and surface states of the hole-formed multicore optical fiber 401, the PLC 403 and the holes 405 and a material of the adhesive agent 404 such that a contact angle between a surface of the element which is brought into contact with the adhesive agent 404 before curing and the adhesive agent 404 before curing becomes less than 90 degrees, at a point of time before the adhesive agent 404 is cured, a relative position between the hole-formed multicore optical fiber 401 and the PLC 403 changes so as to assume a stable state because of an action of a surface tension of the adhesive agent 404 and hence, the hole-formed multicore optical fiber 401 and the PLC 403 assume alignment positions in a state where the surface tension is balanced. Accordingly, by curing the adhesive agent 404 after spontaneous alignment and a capillary action take place, the spontaneous alignment can be realized between the hole-formed multicore optical fiber 401 and the PLC 403.

Further, the adhesive agent 404 before curing flows into the holes 405 of the hole-formed multicore optical fiber 401 because of a capillary action and hence, it is possible to control a distance between the hole-formed multicore optical fiber 401 and the PLC 403 and the inclination of the hole-formed multicore optical fiber 401 and the PLC 403 in a rotational direction about a z axis.

By curing the adhesive agent 404 after the spontaneous alignment and a capillary action at a point of time before the adhesive agent 404 is cured take place, stable optical coupling can be obtained. Accordingly, optical coupling between the hole-formed multicore optical fiber 401 and all waveguide cores of the PLC 403 can be realized by controlling the positions of the hole-formed multicore optical fiber 401 and the PLC 403 in an x axis direction, a y axis direction and a z axis direction and the inclination of the hole-formed multicore optical fiber 401 and the PLC 403 in the rotational direction about the z axis with high accuracy using only passive alignment without using active alignment. Further, a mounting time and a mounting cost can be reduced compared to a case where active alignment is used.

In this embodiment, for example, as shown in FIG. 4D, two holes 405 are formed in the hole-formed multicore optical fiber 401 at symmetrical positions with respect to the plurality of optical fiber cores 402. However, the number of holes formed in the hole-formed multicore optical fiber 401 and the arrangement of such holes can be selected as desired for realizing passive alignment.

### Fifth Embodiment

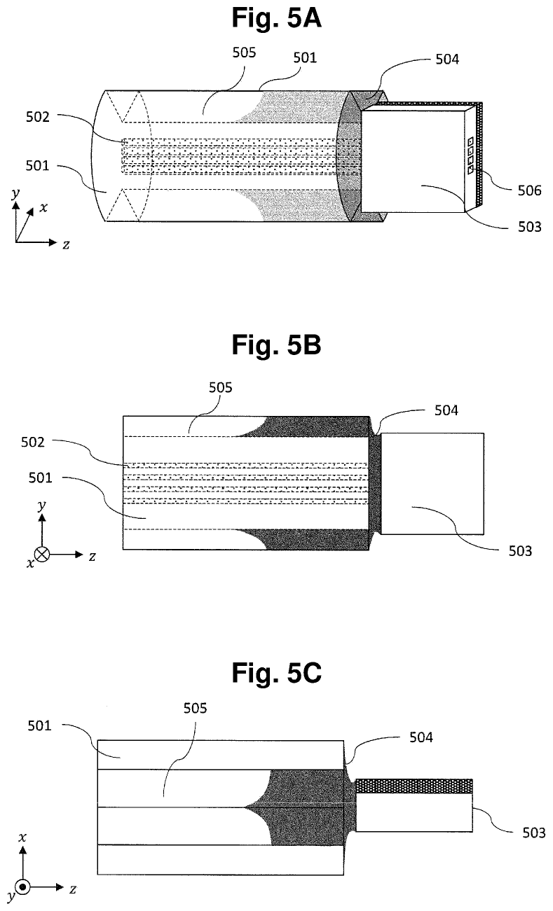

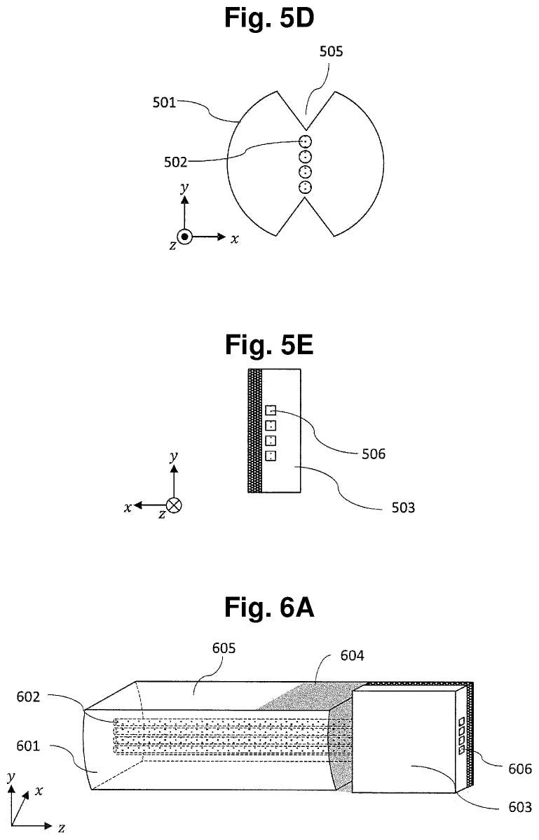

As shown in FIG. 5A to FIG. 5E, an optical coupling structure according to a fifth embodiment of the present invention has a structure where a groove-formed multicore optical fiber 501 and a PLC 503 are coupled to each other by an adhesive agent 504.

As shown in FIG. 5A and FIG. 5B, the groove-formed multicore optical fiber 501 includes: a plurality of optical fiber cores 502; and grooves 505 which are formed on a side surface of the groove-formed multicore optical fiber 501, and have one ends thereof coupled to an end surface of the groove-formed multicore optical fiber 501. In this embodiment, the grooves 505 are formed along a waveguide direction of the hole-formed multicore optical fiber 401 in a state where a cross section taken perpendicular to the longitudinal direction of the hole-formed multicore optical fiber 401 is an approximately V shape. In this embodiment, the plurality of optical fiber cores 502 are arranged in a row in a y direction as viewed from a z direction, and two grooves 505 are formed on an extension of the row of the plurality of optical fiber cores 502 at symmetrical positions with respect to the plurality of optical fiber cores 502.

On the other hand, as shown in FIG. 5A, FIG. 5B and FIG. 5E, a plurality of PLC cores 506 are formed in the PLC 503. These PLC cores 506 are arranged on one straight line along a y direction as viewed from a −z direction.

In the optical coupling structure according to this embodiment, as shown in FIG. 5B, the PLC 503 is fixed to the end surface of the groove-formed multicore optical fiber 501 by the adhesive agent 504, optical axes of the plurality of optical fiber cores 502 and optical axes of the plurality of PLC cores 506 are aligned with each other, and the groove-formed multicore optical fiber 501 and the PLC 503 are optically and mechanically coupled to each other. In such a configuration, a part of the adhesive agent 504 has entered the grooves 505.

In the optical coupling structure according to this embodiment, a part of the adhesive agent 504 before curing flows into the grooves 505 because of expansion of wetting. As shown in FIG. 5B and FIG. 5C, also in the optical coupling structure according to this embodiment, both a contact angle which a surface of the PLC 503 and a surface of the adhesive agent 504 make and contact angles which the end surface of the groove-formed multicore optical fiber 501 and wall surfaces of the grooves 505 and the surface of the adhesive agent 504 make are less than 90 degrees.

Accordingly, by designing materials, profiles and surface states of the groove-formed multicore optical fiber 501, the PLC 503 and the grooves 505 and a material of the adhesive agent 504 such that a contact angle between a surface of the element which is brought into contact with the adhesive agent 504 before curing and the adhesive agent 504 before curing becomes less than 90 degrees, at a point of time before the adhesive agent 504 is cured, a relative position between the groove-formed multicore optical fiber 501 and the PLC 503 changes so as to assume a stable state because of an action of a surface tension of the adhesive agent 504 and hence, the groove-formed multicore optical fiber 501 and the PLC 503 assume alignment positions in a state where the surface tension is balanced. Accordingly, by curing the adhesive agent 504 after spontaneous alignment and a capillary action take place, the spontaneous alignment can be realized between the groove-formed multicore optical fiber 501 and the PLC 503.

Further, the adhesive agent 504 before curing flows into the grooves 505 because of expansion of wetting and hence, it is possible to control a distance between the groove-formed multicore optical fiber 501 and the PLC 503 and the inclination of the groove-formed multicore optical fiber 501 and the PLC 503 in a rotational direction about a z axis.

By curing the adhesive agent 504 after the spontaneous alignment and the expansion of wetting at a point of time before the adhesive agent 504 is cured take place, stable optical coupling can be obtained. Accordingly, optical coupling between the groove-formed multicore optical fiber 501 and all waveguide cores of the PLC 503 can be realized by controlling the positions of the groove-formed multicore optical fiber 501 and the PLC 503 in an x axis direction, a y axis direction and a z axis direction and the inclination of the groove-formed multicore optical fiber 501 and the PLC 503 in the rotational direction about the z axis with high accuracy using only passive alignment without using active alignment. Further, a mounting time and a mounting cost can be reduced compared to a case where active alignment is used.

With such configuration, the fiber can be easily formed by working compared to the optical coupling structure according to the fourth embodiment and hence, the configuration is suitable for small-lot manufacture.

In this embodiment, the description has been made with respect to the case where the grooves 505 are formed in an approximately V-shape in cross section perpendicular to the longitudinal direction of the grooves 505. However, a cross-sectional shape of the groove is not limited to an approximately V shape, and may be an arbitrary shape such as a semicircular shape or a rectangular shape.

Further, in this embodiment, as shown in FIG. 5D, for example, the grooves 505 formed on a side surface of the groove-formed multicore optical fiber 501 are arranged at symmetrical positions with respect to the optical fiber cores 502. However, the number of grooves formed in the side surface of the groove-formed multicore optical fiber 501 and the arrangement of such grooves can be selected as desired for realizing passive alignment.

### Sixth Embodiment

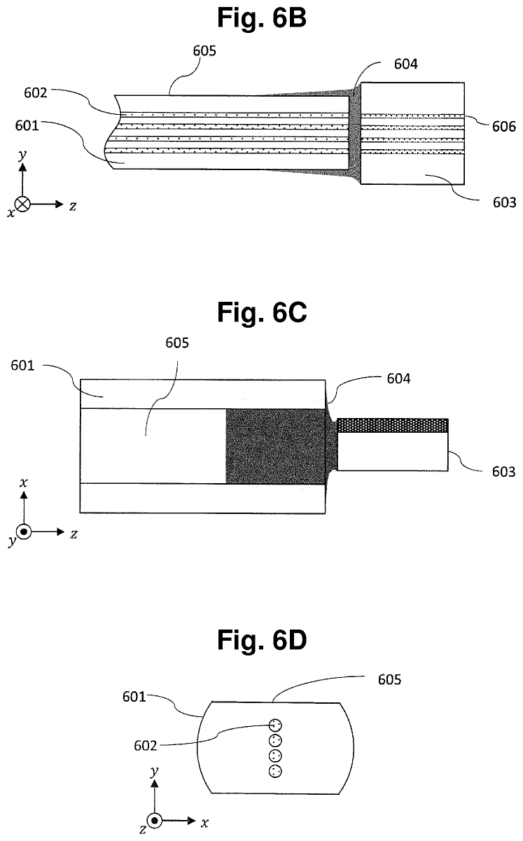

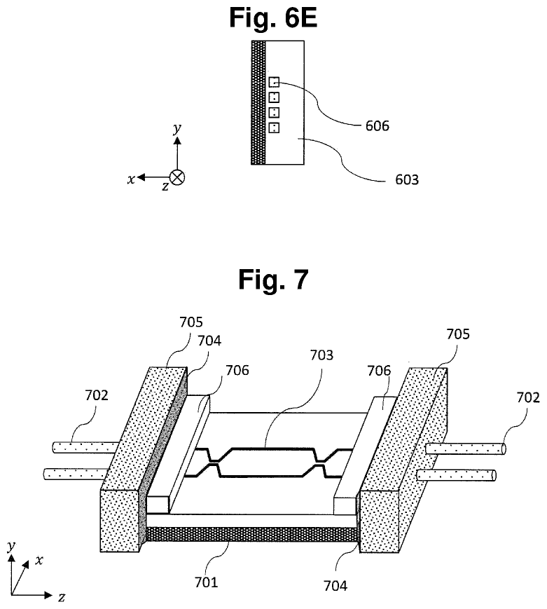

As shown in FIG. 6A to FIG. 6E, an optical coupling structure according to a sixth embodiment of the present invention has a structure where a multicore optical fiber 601 having flat surfaces 605 on a side surface and a PLC 603 are coupled to each other by an adhesive agent 604.

As shown in FIG. 6A and FIG. 6B, the multicore optical fiber 601 includes: a plurality of optical fiber cores 602; and two flat surfaces 605 which are formed on the side surface of the multicore optical fiber 601 along a waveguide direction of the multicore optical fiber 601 in a state where one ends of the two flat surfaces 605 are coupled to an end surface of the multicore optical fiber 601 (hereinafter, the flat surfaces which are formed on the side surface of the multicore optical fiber and are coupled to the end surface of the optical fiber are referred to as “flat side surfaces”). In this embodiment, the plurality of optical fiber cores 602 are arranged in a row in a y direction as viewed from a z direction. Two flat side surfaces 605 are respectively formed on an extension of the row of the plurality of optical fiber cores 602, that is, respectively perpendicular to a y axis direction in which the plurality of optical fiber cores 602 are arranged, at symmetrical positions with respect to the plurality of optical fiber cores 602 between the two flat side surfaces 605.

On the other hand, as shown in FIG. 6A, FIG. 6B and FIG. 6E, a plurality of PLC cores 606 are formed in the PLC 603. These PLC cores 606 are also arranged on one straight line along the y direction as viewed in a −z direction.

In the optical coupling structure according to this embodiment, as shown in FIG. 6B, the PLC 603 is fixed to the end surface of the multicore optical fiber 601 by the adhesive agent 604, optical axes of the plurality of optical fiber cores 602 of the multicore optical fiber 601 and optical axes of the plurality of PLC cores 606 of the PLC 603 are aligned with each other, and the multicore optical fiber 601 and the PLC 603 are optically and mechanically coupled to each other. In such a configuration, a part of the adhesive agent 604 is applied to the flat side surfaces 605 because of expansion of wetting brought about by an action of a surface tension before the adhesive agent 604 is cured.

As shown in FIG. 6B and FIG. 6C, also in the optical coupling structure according to this embodiment, both a contact angle which a surface of the PLC 603 and a surface of the adhesive agent 604 make and contact angles which the end surface of the multicore optical fiber 601 and the flat side surfaces 605 and the surface of the adhesive agent 504 make are less than 90 degrees.

Accordingly, by designing materials, profiles and surface states of the multicore optical fiber 601 having the flat side surfaces 605 and the PLC 603 and a material of the adhesive agent 604 such that a contact angle between a surface of the element which is brought into contact with the adhesive agent 604 before curing and the adhesive agent 604 before curing becomes less than 90 degrees, at a point of time before the adhesive agent 604 is cured, a relative position between the multicore optical fiber 601 having the flat side surfaces 605 and the PLC 603 changes so as to assume a stable state because of an action of a surface tension of the adhesive agent 604 and hence, the multicore optical fiber 601 and the PLC 603 assume alignment positions in a state where the surface tension is balanced. Accordingly, by curing the adhesive agent 604 after spontaneous alignment and a capillary action take place, the spontaneous alignment can be realized between the multicore optical fiber 601 and the PLC 603.

Further, the adhesive agent 604 before curing flows onto the flat side surfaces 605 because of expansion of wetting and hence, it is possible to control a distance between the multicore optical fiber 601 and the PLC 603 and the inclination of the multicore optical fiber 601 and the PLC 603 in a rotational direction about a z axis.

With respect to the multicore optical fiber 601 having the flat side surfaces 605 used in the optical coupling structure according to this embodiment, the multicore optical fiber 601 can be aligned at a fixed position also in the rotational direction about the z axis due to anisotropy in structure with respect to the rotation about the z axis.

With respect to the multicore optical fiber 601 having the flat side surfaces 605, a large number of multicore optical fibers 601 are available in market and hence, the multicore optical fiber 601 can be easily purchased. Accordingly, the optical coupling structure according to this embodiment can be easily realized compared to the optical coupling structures according to the third to fifth embodiments.

Further, in this embodiment, as shown in FIG. 6D, for example, the flat side surfaces 605 are formed on both sides of the multicore optical fiber 601 parallel to each other with the optical fiber cores 602 sandwiched therebetween. However, the number of flat side surfaces formed on the multicore optical fiber 601 and the arrangement of the flat side surfaces can be selected as desired for realizing passive alignment.

### Modification

In the optical coupling structures according to the first to sixth embodiments described above, the description has been made with respect to the case where the optical element which is coupled to the optical fiber is either a lens or a PLC. However, embodiments of the present invention are applicable to cases where, as the optical element, an LD, a PD, a modulator, an optical filter or the like is coupled to the optical fiber. These optical elements are only for an exemplifying purpose, and embodiments of the present invention are applicable to any optical element which is coupled to the optical fiber.

Even in the case where a PLC is used as the optical element, a material which forms the PLC can be arbitrarily selected. For example, in a system formed of a quartz-based PLC, a support substrate may be a Si substrate and a clad layer may be made of SiO₂. However, besides the quartz-based PLC, it is possible to arbitrarily adopt a PLC having a waveguide structure made of a material based on a dielectric material such as a TaO₂/SiO₂ or a lithium niobate or a material based on a compound semiconductor, a PLC based on a silicon photonics material and the like. Accordingly, an embodiment optical element in the present invention also includes a waveguide type LD and a waveguide type PD in its category.

In the optical coupling structure according to the second and third embodiments described above, the description has been made with respect to the embodiments where the hole-formed optical fiber is used. However, the hole-formed optical fiber also includes a photonic crystal optical fiber and a holey fiber in its category. Further, embodiments of the present invention are applicable to a hole-formed optical fiber which is classified neither into a photonic crystal optical fiber nor a holey fiber.

In the second to sixth embodiments described above, the description has been made with respect to the example where two holes are formed in the optical fiber, the example where two grooves are formed in the optical fiber, and the example where two flat side surfaces are formed in the optical fiber. However, in embodiments of the present invention, whether or not the holes, the grooves, or the flat side surfaces are formed in the optical fiber is arbitrary. Further, even when the holes, the grooves, or the flat side surfaces are formed in the optical fiber, the number of the holes, the number of the grooves, or the number of the flat side surfaces is not limited to two, and may be any arbitrary number of one or more.

In the fourth to sixth embodiments, the description has been made with respect to the example where the multicore optical fiber is used as the optical fiber. In these embodiments, the multicore optical fiber is exemplified as an example of an optical fiber which is not optically axisymmetric unlike a single-mode and single-core optical fiber used in general. In embodiments of the present invention, the optical fiber is not limited to a particular kind of optical fiber. The embodiments of the present invention are applicable to any kinds of optical fibers including optical fibers which are not optically axisymmetric such as a polarization maintaining fiber in addition to the multicore optical fiber, not to mention, a single-mode and single-core optical fiber used in general and the above-mentioned multicore optical fiber.

Similarly, the optical element such as a PLC may not have an optically axisymmetric structure.

### REFERENCE SIGNS LIST

101 Optical fiber

201, 301 Hole-formed optical fiber

401 Hole-formed multicore optical fiber

501 Groove-formed multicore optical fiber

601 Multicore optical fiber having flat side surfaces

102, 202, 302, 402, 502, 602 Optical fiber core

103, 203 Lens

303, 403, 503, 603 PLC

104, 204, 304, 404, 504, 604 Adhesive agent

205, 305, 405 Hole

505 Groove

605 Flat side surface

306, 406, 506, 606 PLC core

1.-8. (canceled)

9. An optical coupling structure comprising:
at least one optical element;
at least one optical fiber having an end surface facing the optical element; and
an adhesive agent on at least the end surface of the optical fiber and a part of the optical element so as to optically and mechanically couple the optical element and the optical fiber,
wherein both a contact angle which a surface of the optical element and a surface of the adhesive agent make and a contact angle which a surface of the optical fiber and the surface of the adhesive agent make are less than 90 degrees.

10. The optical coupling structure of claim 9, wherein the optical fiber has a hole which opens at the end surface, and a part of the adhesive agent is disposed in the hole.

11. The optical coupling structure of claim 10, wherein the hole has a columnar shape which is parallel to a waveguide direction of the optical fiber.

12. The optical coupling structure of claim 9, wherein the optical fiber has a groove on a side surface of the optical fiber, one end of the groove being coupled to the end surface, and a part of the adhesive agent is disposed in the groove.

13. The optical coupling structure of claim 12, wherein the groove extends along a waveguide direction of the optical fiber.

14. The optical coupling structure of claim 9, wherein the optical fiber has a flat surface on a side surface of the optical fiber, one end of the flat surface being coupled to the end surface, and a part of the adhesive agent is on at least a part of the flat surface.

15. The optical coupling structure of claim 9, wherein at least one of the optical element and the optical fiber does not have an optically axisymmetric structure.

16. The optical coupling structure of claim 9, wherein the optical element is a planar lightwave circuit.

17. An optical coupling structure comprising:
an optical fiber comprising a fiber core and a clad portion, the clad portion having a hole parallel to the fiber core;
a planar lightwave circuit comprising a waveguide core, a first optical axis of the fiber core aligned with a second optical axis of the waveguide core; and
an adhesive having a first portion and a second portion, the first portion optically and mechanically coupling a first surface of the optical fiber to a second surface of the planar lightwave circuit, the second portion disposed in the hole, a third surface of the adhesive forming a first acute angle with the first surface of the optical fiber, the third surface of the adhesive forming a second acute angle with the second surface of the planar lightwave circuit.

18. The optical coupling structure of claim 17, wherein the third surface of the adhesive is a curved surface that extends between the optical fiber and the planar lightwave circuit.

19. The optical coupling structure of claim 17, wherein a first portion of the hole proximate the planar lightwave circuit is filled by the adhesive, and a second portion of the hole distal the planar lightwave circuit is hollow.

20. The optical coupling structure of claim 17, wherein the hole is one of a plurality of holes, and the holes are disposed at symmetrical positions with respect to the fiber core.

21. A method comprising:
forming an adhesive on an end surface of an optical fiber and on a surface of an optical element;
changing a relative position between the optical fiber and the optical element so that a surface of the adhesive forms a first acute angle with the end surface of the optical fiber and so that the surface of the adhesive forms a second acute angle with the surface of the optical element; and
after changing the relative position between the optical fiber and the optical element, curing the adhesive.

22. The method of claim 21, wherein the adhesive comprises a thermosetting adhesive agent.

23. The method of claim 21, wherein the adhesive comprises an ultraviolet curing adhesive agent.

24. The method of claim 21, wherein the optical fiber comprises a hole parallel to the optical fiber, a portion of the adhesive formed in the hole.

25. The method of claim 21, wherein the optical fiber comprises a groove parallel to the optical fiber, a portion of the adhesive formed in the groove.

26. The method of claim 21, wherein the optical fiber comprises a flat surface parallel to the optical fiber, a portion of the adhesive formed on the flat surface.

27. The method of claim 21, wherein the optical element is a lens.

28. The method of claim 21, wherein the optical element is a planar lightwave circuit comprising a waveguide core, the optical fiber comprises a fiber core, and a first optical axis of the fiber core is aligned with a second optical axis of the waveguide core.
